(19) United States
(12) Patent Application Publication
(10) Pub. No.: US 2025/0218076 A1
(43) Pub. Date: Jul. 3, 2025

(54) IMAGE-TEXT EMBEDDING MODELS WITH ENHANCED COLOR UNDERSTANDING

(71) Applicant: Google LLC, Mountain View, CA (US)

(72) Inventors: Arjun Reddy Akula, Sunnyvale, CA (US); Garima Pruthi, San Jose, CA (US)

(21) Appl. No.: 18/401,184

(22) Filed: Dec. 29, 2023

(51) Int. Cl. G06T 11/60; G06T 7/12; G06T 7/90; G06T 11/00; G06V 10/56

(52) U.S. Cl. CPC G06T 11/60; G06T 7/12; G06T 7/90; G06T 11/001; G06V 10/56; G06T 2207/10024

(57) ABSTRACT

Provided is a method that operates to enhance the color understanding capabilities of an image-text embedding model. The proposed approach can include modifying an initial image depicting an object of a certain color to generate a modified image where the object has a different color. This can be done by adjusting the color values of the pixels in the initial image. For example, an image of a red apple can be modified to depict a green apple. The technology then trains an image-text embedding model using this modified image and a text prompt that describes the modified image.

### FIELD

The present disclosure relates generally to computer vision and language understanding. More particularly, the present disclosure relates to the enhancement of color comprehension capabilities in machine-learned image-text embedding models.

### BACKGROUND

Image-text embedding models have shown remarkable capabilities in image and text representation. An image-text embedding model can be configured to generate consistent embeddings for image inputs and text inputs. However, a significant technical problem with image-text embedding models is their limitation to understand precise colors.

In the current state of the art, when image-text embedding models are tasked with retrieving images based on exact RGB (Red, Green, Blue) colors, they frequently struggle to accurately retrieve images that align with the specified color, particularly when colors exhibit subtle resemblances. This limitation not only impacts the performance of image retrieval tasks but also extends to downstream applications reliant on these models, such as automated content creation.

Furthermore, the direct fine-tuning of these models for color understanding encounters inherent technical challenges, including the risks of overfitting and mode-collapse, primarily stemming from the limited availability of image-text pairs explicitly describing precise colors. For example, existing datasets often prioritize broader color terms over specifying exact RGB values.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to improve the robustness of an image-text embedding model to color specificity. The method includes: obtaining, by a computing system comprising one or more computing devices, an initial image that depicts an object having a first color; modifying, by the computing system, color values of the initial image to generate a modified image in which the object has a second, different color; obtaining, by the computing system, a text prompt that describes the modified image, wherein the text prompt includes one or more text tokens that correspond to the second color; and training, by the computing system, an image-text embedding model using the modified image and the text prompt.

Another example aspect of the present disclosure is directed to computer system comprising an image-text embedding model, wherein the image-text embedding model has been trained by the performance of training operations. The training operations included: obtaining, by a computing system comprising one or more computing devices, an initial image that depicts an object having a first color; modifying, by the computing system, color values of the initial image to generate a modified image in which the object has a second, different color; obtaining, by the computing system, a text prompt that describes the modified image, wherein the text prompt includes one or more text tokens that correspond to the second color; and training, by the computing system, an image-text embedding model using the modified image and the text prompt.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an overview of an example dataset construction process according to example embodiments of the present disclosure.

FIG. 2 depicts an overview of an example training process according to example embodiments of the present disclosure.

FIG. 3A depicts a block diagram of an example computing system according to example embodiments of the present disclosure.

FIG. 3B depicts a block diagram of an example computing device according to example embodiments of the present disclosure.

FIG. 3C depicts a block diagram of an example computing device according to example embodiments of the present disclosure.

Reference numerals that are repeated across plural figures are intended to identify the same features in various implementations.

### DETAILED DESCRIPTION

Generally, the present disclosure is directed to systems and methods that enhance the color comprehension capabilities of image-text embedding models. Traditional image-text embedding models have shown remarkable capabilities in image and text representation, but a notable gap exists in their understanding of precise colors. This limitation is particularly significant in various practical design domains, where precise color understanding plays a crucial role in establishing perceptions or other “look and feel”.

Example implementations of the present disclosure address this gap by extending an image-text embedding model's capability to grasp the nuances of precise colors. It adapts to both recognized HTML colors and out-of-vocabulary RGB inputs through the utilization of a curated dataset of image-text pairs. These pairs can be repurposed for fine-tuning with any desired color. Importantly, these enhancements are achieved without compromising model performance on established benchmarks.

In particular, during the fine-tuning process, example implementations of the present disclosure encourage the disentanglement of color-relevant information from color-irrelevant details. This feature is particularly useful when colors exhibit subtle resemblances.

More particularly, one example aspect of the present disclosure is directed to a computer-implemented method that operates to enhance the color understanding capabilities of an image-text embedding model. The proposed approach can include modifying an initial image depicting an object of a certain color to generate a modified image where the object has a different color. This can be done by adjusting the color values of the pixels in the initial image. For example, an image of a red apple can be modified to depict a green apple. The technology then trains an image-text embedding model using this modified image and a text prompt that describes the modified image.

In some implementations, the initial image used in the present disclosure can be obtained by processing an initial prompt through a text-to-image generation model. This initial prompt includes text tokens that correspond to the first color of the object. For instance, the initial prompt could be “a red apple,” and the text-to-image generation model could generate an image of a red apple based on this prompt. The text-to-image generation model can use a denoising diffusion model to generate the initial image.

In some implementations, the initial prompt can be modified to generate the text prompt that describes the modified image. This is done by replacing the text tokens that correspond to the first color with text tokens that correspond to the second color. For example, if the initial prompt is “a red apple” and the second color is green, the modified text prompt would be “a green apple.” The initial prompt can be generated using a pre-trained language model, which can generate diverse and clear text prompts.

Another example aspect is directed to a method for modifying the color values of the initial image to generate the modified image. For example, this can include processing the initial image with a segmentation model to segment a portion of the image that depicts the object. The color values for the pixels included in this portion are then adjusted to the second color. For instance, if the initial image depicts a red apple and the second color is green, the pixels in the segmented portion of the image that depict the apple are adjusted to green.

In some implementations, the second color used to modify the initial image can be a brand-specific color. This means that the technology can be used to generate images of objects in specific colors associated with particular brands. For example, an image of a product can be modified to depict the product in a color associated with a specific brand.

In some implementations, the present disclosure employs rare-text tokens to correspond to the second color in the text prompt. This enables the technology to handle colors that are not recognized as standard HTML colors. For example, a rare-text token could be used to represent a specific shade of aquamarine blue that is not included in the standard HTML color palette.

In some implementations, the image-text embedding model used in the present disclosure comprises an image encoder and a text encoder. The image encoder processes the modified image to generate an image embedding, while the text encoder processes the text prompt to generate a text embedding. The model can be trained using a CLIP loss between the image embedding and the text embedding.

In some implementations, in addition to the CLIP loss, the present disclosure also incorporates a hard negative loss in the training of the image-text embedding model. This involves generating one or more hard negative images that depict the object in one or more different colors, and applying a hard negative loss between the image embedding for the modified image and the image embeddings for the hard negative images. This helps the model to learn to differentiate between very similar colors.

In some implementations, the present disclosure also applies a text prior loss and an image prior loss during the training of the image-text embedding model. The text prior loss is applied between the text embedding for the text prompt and a reference text embedding generated for the text prompt by a reference version of the text encoder. The image prior loss is applied between the image embedding for the modified image and a reference image embedding generated for the modified image by a reference version of the image encoder. These losses help to preserve the semantic context of images and text during the training process.

Another example aspect is directed to a computer system that includes an image-text embedding model trained according to the disclosed method. This system can use the image-text embedding model to perform various tasks, such as text-to-image retrieval, image-to-text retrieval, image-to-image retrieval, and text-to-image generation. For example, the system can retrieve images that correspond to specific color descriptions, generate images based on text prompts that include specific color descriptions, retrieve text descriptions that correspond to specific colors in images, and retrieve images that depict objects of the same color.

The systems and methods of the present disclosure provide a number of technical effects and benefits. In particular, the present disclosure addresses the technical problem of precise color comprehension in image-text embedding models. Existing image-text embedding models, while successful in many applications, demonstrate a significant limitation in understanding and accurately representing precise color information. The disclosure provides a technical solution to this problem by enhancing the color comprehension capabilities of these models.

The technical solution proposed in the disclosure involves a novel fine-tuning process that enhances the model's ability to understand and represent precise colors. This is achieved through the use of a curated dataset of high-quality image-text pairs, which can be repurposed for fine-tuning with any desired color. The disclosure further introduces a unique process of disentanglement during the fine-tuning process, which enables the model to differentiate color-relevant information from color-irrelevant details effectively.

Another technical solution also includes a novel approach to handle colors that are not recognized as standard HTML colors. This can be achieved by associating each unrecognized color with a unique token in the vocabulary, thus enabling the model to comprehend and accurately represent a broader range of precise colors.

The disclosure also provides a technical solution to the problem of overfitting and mode-collapse, which commonly occurs due to the limited availability of image-text pairs that explicitly describe precise colors. This can be achieved by incorporating hard negatives into the fine-tuning process and applying a text prior loss and an image prior loss. These technical measures effectively mitigate overfitting to the limited training set and preserve the semantic context of images and text during the training process.

The improved image-text embedding models can be applied to a number of practical applications. As one example, accurate color comprehension is a critical aspect in many practical applications such as advertising, branding, design, and digital content creation. Precise color understanding plays a fundamental role in these domains, where it is pivotal for establishing brand recognition, influencing consumer perception and maintaining brand integrity in digital representations. For instance, several brands have established their brand identity by designing unique color palettes instantly recognizable worldwide.

Therefore, the image-text embedding models with improved color understanding can be applied to these domains and others to perform a number of tasks, such as text-to-image retrieval, image-to-text retrieval, image-to-image retrieval, and text-to-image generation. For example, the system can retrieve images that correspond to specific color descriptions, generate images based on text prompts that include specific color descriptions, retrieve text descriptions that correspond to specific colors in images, and retrieve images that depict objects of the same color. For example, the image-text embedding model can generate embedding(s) for image and/or text input(s) in furtherance of these tasks.

With reference now to the Figures, example embodiments of the present disclosure will be discussed in further detail.

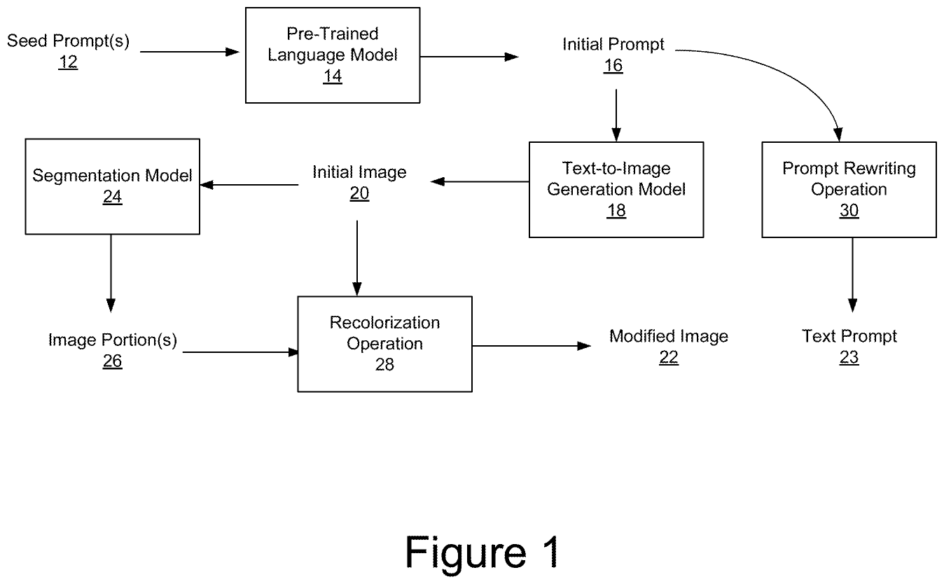

FIG. 1 provides a schematic overview of an embodiment of the present disclosure. The figure illustrates a pipeline for constructing a dataset for training and testing an image-text embedding model, which includes several stages and components.

FIG. 1 can be divided into several sections that sequentially depict the dataset construction process. The first component of FIG. 1 can be a set of seed prompts 12. These seed prompts 12 can be short descriptions or phrases that explicitly specify RGB color attributes for objects. For example, the seed prompt can be “a red apple.” As one example, the seed prompts 12 may be constructed from a database of common objects and their associated color attributes, for instance, “a red rose” or “a blue sky”.

These seed prompts 12 can be provided to a pre-trained language model 14. The language model 14 can be capable of generating additional prompts based on the seed prompts 12. For example, the language model 14 can generate an initial prompt 16 such as “a ripe red apple on a wooden table.” The initial prompt 16 can include one or more text tokens that correspond to a specific color, such as “red.” The pre-trained language model 14 could be a so-called “large language model” that has been trained on a large corpus of diverse text to predict the next word in a sentence.

Next, the initial prompt 16 can be processed with a text-to-image generation model 18. This model 18 can be a denoising diffusion model which can generate an initial image 20 based on the initial prompt 16. This initial image 20, for example, can depict a red apple on a wooden table.

The color values of the initial image 20 can then be modified (e.g., by a recolorization operation 28) to generate a modified image 22. The object in the modified image 22 can have a different color than the object in the initial image 20. For example, the red apple in the initial image 20 can be modified to appear aquamarine blue in the modified image 22.

In some implementations, this process can involve processing the initial image 20 with a segmentation model 24 to segment the portions 26 of the image that depict the object, and then adjusting (e.g., by a recolorization operation 28) the color values for the pixels included in those portions 26 to the second color. The segmented portions 26 can include all pixels that the segmentation model 24 identifies as belonging to the object referred to in the initial prompt 16. The recolorization operation 28 can utilize a color transfer algorithm to adjust the color values of the segmented portions 26, replacing the first color with the second, different color. The second, different color can be a random color selected from a database of colors or can be a user-specified color.

In addition, the initial prompt 16 can be modified to generate a text prompt 23 that corresponds to the modified image 22. This modification process can involve replacing the one or more text tokens in the initial prompt 16 that correspond to the first color with one or more text tokens that correspond to the second color. For example, the initial prompt “a ripe red apple on a wooden table” can be modified to “a ripe aquamarine blue apple on a wooden table” to form the text prompt 23 that corresponds to the modified image 22. Together, the modified image 22 and text prompt 23 can be used as a training pair for a text-image model.

The dataset construction process can further involve identifying unique identifiers for the desired RGB colors. These identifiers can be rare-token identifiers that do not have strong associations with specific concepts or meanings. For example, the identifier for the color aquamarine blue can be a three-letter identifier such as “hta”.

The processes depicted in FIG. 1 can be iterative and can be repeated for different objects and colors to create a diverse dataset. This dataset can then be used to train an image-text embedding model to recognize any RGB color. The dataset can also be used to evaluate the model's performance in different settings, such as text-to-image retrieval and image-to-text retrieval.

Several different embodiments of FIG. 1 are possible. For example, the segmentation model 24 used to segment the object in the initial image 20 can be replaced with different segmentation models. Similarly, the pre-trained language model 14 and the text-to-image generation model 18 can be replaced with other models. Furthermore, the method described in FIG. 1 can also be used to modify the color values of multiple objects in the initial image 20, or to generate multiple modified images 22 with different colors from a single initial image 20.

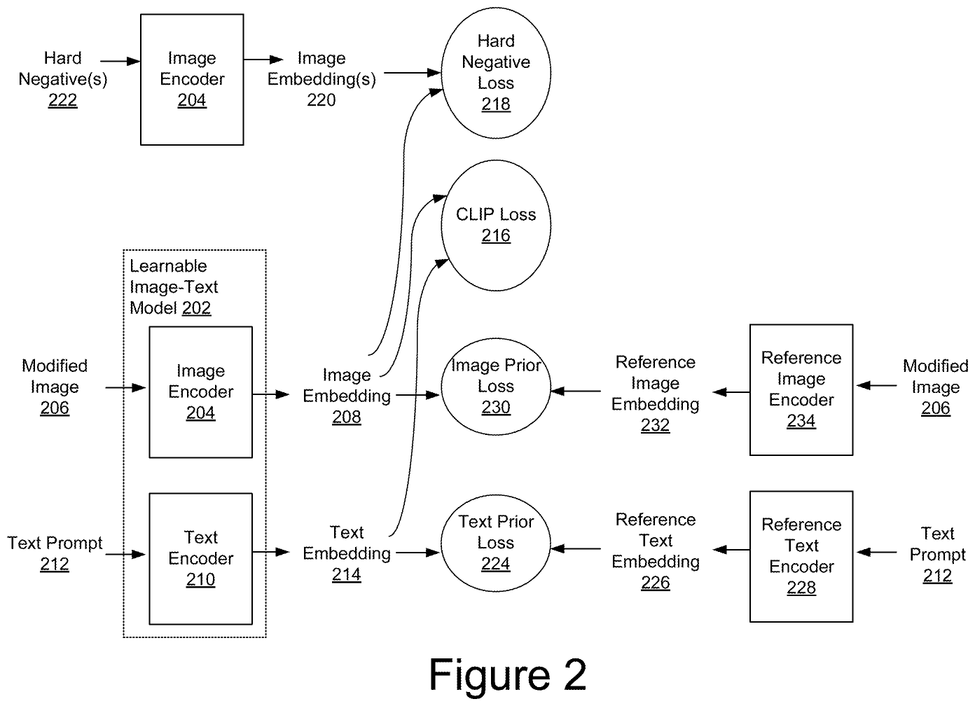

Referring to FIG. 2, an exemplary embodiment of the present disclosure illustrates a multi-faceted framework for fine-tuning an image-text embedding model. This framework includes multiple components designed to ensure the successful comprehension and representation of precise colors while preserving the semantic context of images and text. The embodiment shown in FIG. 2 presents a learnable text-image model 202 that contains two key elements: an image encoder 204 and a text encoder 210.

The image encoder 204 can process a modified image 206 to generate an image embedding 208. The modified image 206, as described earlier, depicts an object having a distinct color (e.g., the “second” color). This image encoder 204 can have various architectures. In one example, it can be a pre-trained convolutional neural network which is capable of generating an image embedding 208 from the input modified image 206.

The text encoder 210 can process a text prompt 212 to generate a text embedding 214. The text prompt 212 corresponds to the modified image 206 and describes the object of the second color. The text encoder 210 can have various architectures. As examples, the text encoder 210 can be a pre-trained transformer model which can generate the text embedding 214 from the input text prompt 212.

In some implementations, the text-image model 202 can be trained using a contrastive loss between the image embedding 208 and the text embedding 214. This contrastive loss, also known as CLIP loss 216, can operate to minimize the distance between the image embedding 208 and the text embedding 214 for a given image-text pair while maximizing the distance between the image embedding 208 and the text embeddings for non-matching text prompts or vice versa. The CLIP loss 216 can be computed using a variety of distance metrics, such as cosine similarity or Euclidean distance.

In addition or alternatively, the training of the text-image model 202 can include a hard negative loss component 218. This loss component involves generating one or more hard negative images 222 that depict the same object as the modified image 206 but in different colors. The image encoder 204 generates image embeddings 220 for these hard negative images 222, and the hard negative loss 218 is applied between the image embedding 208 for the modified image 206 and the image embeddings 220 for the hard negative images 222. The hard negative loss 218 is designed to encourage the text-image model 202 to differentiate between subtle color differences.

In some implementations, the hard negative images 222 can be generated by modifying individual color channels (R, G, or B) of the modified image by a specified delta value, creating hard negatives that closely resemble the modified image while differing only in color. This augmentation significantly reinforces the model's capacity to grasp the intricacies of precise RGB colors. In another example, the hard negative images 222 can be generated by replacing the color name in the text prompts with the closest color shades.

In some implementations, the present disclosure also incorporates a regularization component to prevent overfitting and preserve the semantic context of images and text during the fine-tuning process. This component includes a text prior loss 224 and an image prior loss 230.

The text prior loss 224 can be applied between the text embedding 214 for the text prompt 212 and a reference text embedding 226 generated for the text prompt 212 by a reference version 228 of the text encoder. The text prior loss 224 serves to preserve the text embeddings for a set of image-text pairs during fine-tuning.

Similarly, the image prior loss 230 is applied between the image embedding 208 for the modified image 206 and a reference image embedding 232 generated for the modified image 206 by a reference version 234 of the image encoder. The image prior loss 230 serves to preserve the image embeddings for a set of image-text pairs during fine-tuning.

To calculate the text prior loss 224, the reference version 228 of the text encoder can be a previously trained text encoder, such as a checkpoint of the text encoder prior to finetuning, that has been trained on a large corpus of text. This reference text encoder 228 can generate a reference text embedding 226 for the text prompt 212. The text prior loss 224 can then be calculated as the difference between the text embedding 214 generated by the text encoder 210 and the reference text embedding 226.

Similarly, to calculate the image prior loss 230, the reference version 234 of the image encoder can be a previously trained image encoder, such as a checkpoint of the image encoder prior to finetuning, that has been trained on a large dataset of images. This reference image encoder 234 can generate a reference image embedding 232 for the modified image 206. The image prior loss 230 can then be calculated as the difference between the image embedding 208 generated by the image encoder 204 and the reference image embedding 232.

The overall loss function (L) used in fine-tuning the text-image model 202 can be a combination of the CLIP loss 216, the hard negative loss 218, the image prior loss 230, and the text prior loss 224. Each of these loss components can be weighted by a corresponding lambda parameter (21, 22, 23). The lambda parameters can be used to control the relative importance of each loss component in the overall loss function. The model 202 and its component parts (e.g., encoders 204 and 210) can be trained based on the overall loss function. For example, a gradient of the overall loss function can be backpropagated through the learnable model 202.

The approach illustrated in FIG. 2 provides several advantages. Firstly, the use of hard negatives during fine-tuning encourages the disentanglement of color-relevant information from color-irrelevant details, thus enhancing the model's understanding of precise colors. Secondly, the inclusion of a text prior loss and an image prior loss effectively mitigates overfitting to the limited training set and preserves the semantic context of images and text during the training process.

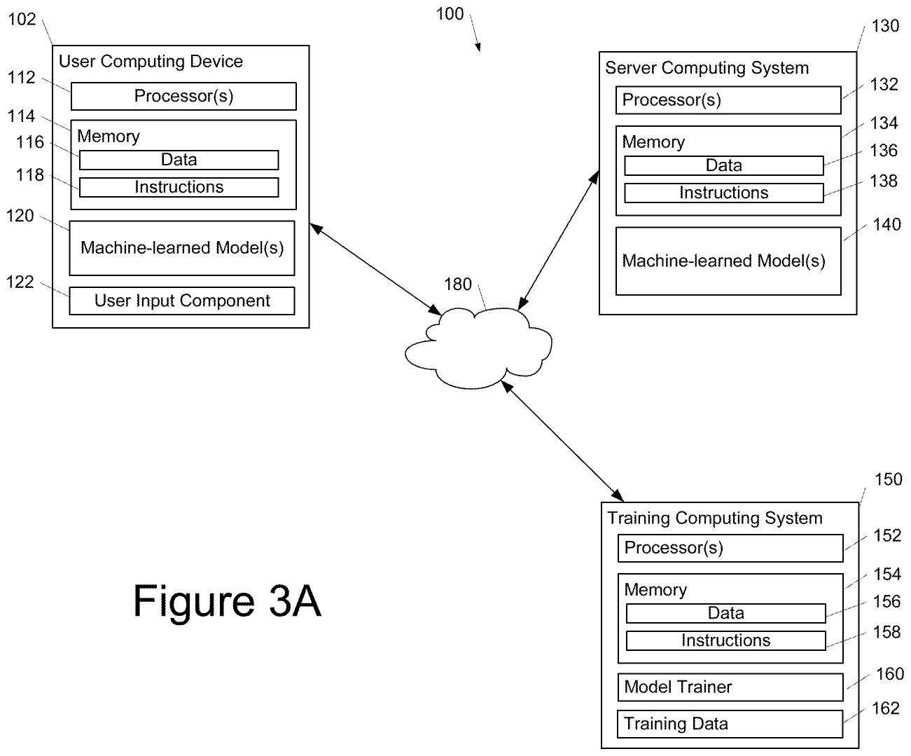

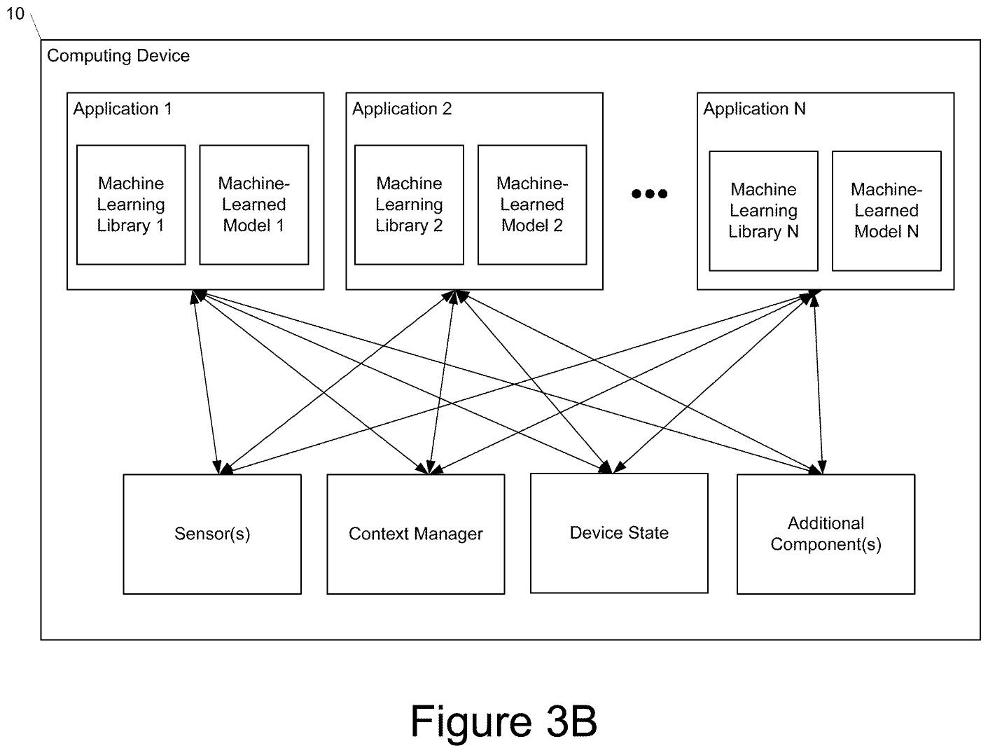

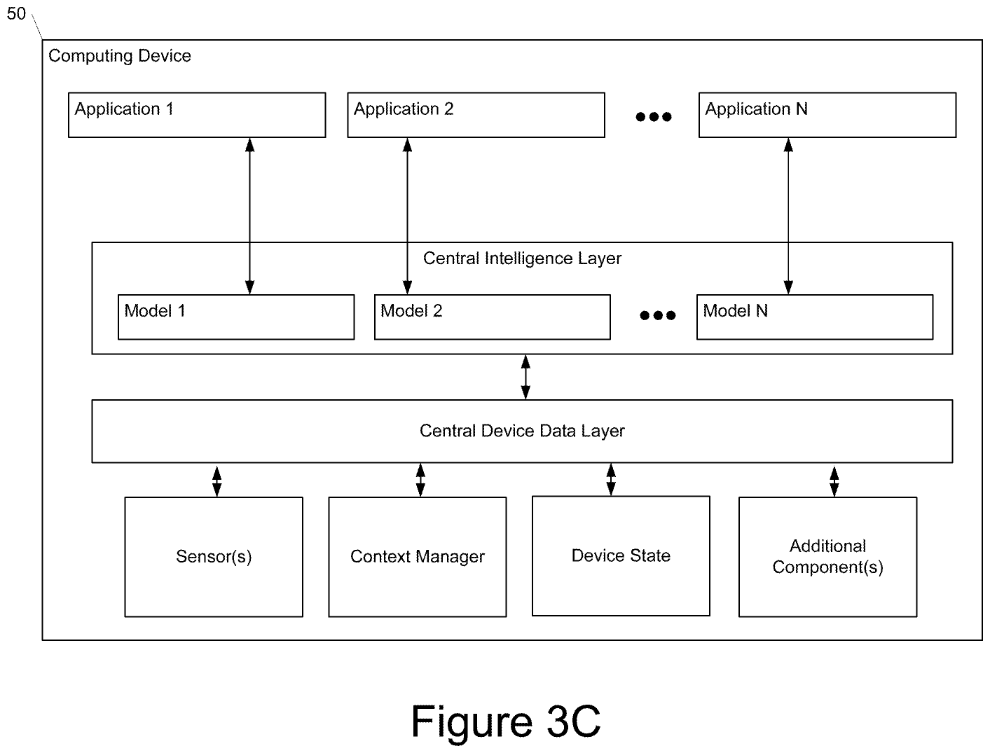

FIG. 3A depicts a block diagram of an example computing system 100 that according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example machine-learned models 120 are discussed with reference to FIGS. 1-2.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120.

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a image and/or text embedding service). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 140 are discussed with reference to FIGS. 1-2.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, pairs of modified images and corresponding text prompts.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 3A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 3B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 3B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 3C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 3C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 3C, the central device data layer can communicate with a number of other components of the computing device, such as, for example, one or more sensors, a context manager, a device state component, and/or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

What is claimed is:

1. A computer-implemented method to improve the robustness of an image-text embedding model to color specificity, the method comprising:
obtaining, by a computing system comprising one or more computing devices, an initial image that depicts an object having a first color;
modifying, by the computing system, color values of the initial image to generate a modified image in which the object has a second, different color;
obtaining, by the computing system, a text prompt that describes the modified image, wherein the text prompt includes one or more text tokens that correspond to the second color; and
training, by the computing system, an image-text embedding model using the modified image and the text prompt.

2. The computer-implemented method of claim 1, wherein obtaining the initial image comprises:
obtaining, by the computing system, an initial prompt, wherein the initial prompt includes one or more text tokens that correspond to the first color; and
processing, by the computing system, the initial prompt with a text-to-image generation model to generate the initial image.

3. The computer-implemented method of claim 2, further comprising:
modifying, by the computing system, the initial prompt to generate the text prompt, wherein said modifying comprises replacing the one or more text tokens that correspond to the first color with the one or more text tokens that correspond to the second color.

4. The computer-implemented method of claim 2, wherein obtaining the initial prompt comprises generating the initial prompt using a pre-trained language model.

5. The computer-implemented method of claim 2, wherein the text-to-image generation model comprises a denoising diffusion model.

6. The computer-implemented method of claim 1, wherein modifying, by the computing system, color values of the initial image to generate the modified image in which the object has the second, different color comprises:
processing, by the computing system, the initial image with a segmentation model to segment a portion of the initial image that depicts the object; and
adjusting, by the computing system, color values for pixels included in the portion to the second color.

7. The computer-implemented method of claim 1, wherein the second color comprises a brand-specific color.

8. The computer-implemented method of claim 1, wherein the one or more text tokens that correspond to the second color comprise rare-text tokens.

9. The computer-implemented method of claim 1, the image-text embedding model comprises an image encoder configured to process the modified image to generate an image embedding and a text encoder configured to process the text prompt to generate a text embedding.

10. The computer-implemented method of claim 9, wherein training, by the computing system, the image-text embedding model using the modified image and the text prompt comprises applying, by the computing system a CLIP loss between the image embedding and the text embedding.

11. The computer-implemented method of claim 9, wherein training, by the computing system, the image-text embedding model using the modified image and the text prompt comprises:
generating, by the computing system, one or more hard negative images that depict the object having one or more third colors; and
applying, by the computing system, a hard negative loss between the image embedding generated by the image encoder for the modified image and one or more image embeddings generated by the image encoder for the one or more hard negative images.

12. The computer-implemented method of claim 9, wherein training, by the computing system, the image-text embedding model using the modified image and the text prompt comprises applying, by the computing system, a text prior loss between the text embedding generated by the text encoder for the text prompt and a reference text embedding generated for the text prompt by a reference version of the text encoder.

13. The computer-implemented method of claim 9, wherein training, by the computing system, the image-text embedding model using the modified image and the text prompt comprises applying, by the computing system, an image prior loss between the image embedding generated by the image encoder for the modified image and a reference image embedding generated for the modified image by a reference version of the image encoder.

14. The computer-implemented method of claim 1, wherein the second color is selected by the user from an RGB color space.

15. A computer system comprising an image-text embedding model, wherein the image-text embedding model has been trained by the performance of training operations, the training operations comprising:
obtaining, by a computing system comprising one or more computing devices, an initial image that depicts an object having a first color;
modifying, by the computing system, color values of the initial image to generate a modified image in which the object has a second, different color;
obtaining, by the computing system, a text prompt that describes the modified image, wherein the text prompt includes one or more text tokens that correspond to the second color; and
training, by the computing system, an image-text embedding model using the modified image and the text prompt.

16. The computer system of claim 15, wherein the computer system is configured to use the image-text embedding model to perform text-to-image retrieval.

17. The computer system of claim 15, wherein the computer system is configured to use the image-text embedding model to perform image-to-text retrieval.

18. The computer system of claim 15, wherein the computer system is configured to use the image-text embedding model to perform image-to-image retrieval.

19. The computer system of claim 15, wherein the computer system is configured to use the image-text embedding model to perform text-to-image generation.

20. One or more non-transitory computer-readable media that collectively store an image-text embedding model that has been trained by the performance of training operations, the training operations comprising:
obtaining, by a computing system comprising one or more computing devices, an initial image that depicts an object having a first color;
modifying, by the computing system, color values of the initial image to generate a modified image in which the object has a second, different color;
obtaining, by the computing system, a text prompt that describes the modified image, wherein the text prompt includes one or more text tokens that correspond to the second color; and
training, by the computing system, an image-text embedding model using the modified image and the text prompt.
